(19) United States
(12) Patent Application Publication
(10) Pub. No.: US 2004/0062271 A1
(43) Pub. Date: Apr. 1, 2004

(54) Method and system for providing control and monitoring functionality for a telecommunication switching domain

(76) Inventors: Neal C. Oliver, Florham Park, NJ (US); Paul A. Rupsis, Winfield, IL (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/256,568

(22) Filed: Sep. 26, 2002

(51) Int. Cl. H04L 12/56

(52) U.S. Cl. 370/466; 370/352

(57) ABSTRACT

A method and system is provided for using H.248 to provide control and monitoring functionality for a computer supported telecommunication applications (CSTA) switching domain. The system includes a media gateway controller. The media gateway controller includes a translator to translate commands from one protocol to another to allow the commands to be communicated between a CSTA server and a media gateway. When a CSTA command is received by the media gateway controller, the media gateway controller translates the command into a protocol understood by a media gateway, such as a H.248 protocol. The translated command may then be processed and H.248 commands may then be transmitted to the media gateway. When a message is received from the media gateway, the media gateway controller translates the message into the CSTA protocol. CSTA messages may then be transmitted to the CSTA server.

### BACKGROUND

1. Field

Embodiments of the invention relate to the field of internet telephony, and more specifically to providing control and monitoring functionality for a telecommunication switching domain.

2. Background Information and Description of Related Art

Internet telephony is increasing in popularity. In response, different standards have been developed to provide methods for completing calls over a packet switched network. One such standard is the H.323 standard, defined and approved by the International Telecommunications Unit (ITU), Geneva in 1996. Originally, the H.323 standard was promoted as a way to provide consistency in audio, video, and data packet transmissions in the event that a local area network (LAN) did not provide guaranteed service quality (QoS). It has become the standard for interoperability in audio, video and data transmissions as well as Internet phone and voice-over-IP (VoIP) because it addresses call control and management for both point-to-point and multipoint conferences as well as gateway administration of media traffic, bandwidth and user participation. However, H.323 is not capable of scaling to larger public networks.

Another standard, the H.248 standard, was approved in August 2000 by the ITU to provide greater scalability and flexibility and enable even low-cost gateway devices to interface in a standard way with the signaling systems found in conventional telephone networks. The H.248 standard, which was developed by the ITU jointly with the Internet Engineering Task Force (IETF), is also known as Media Gateway Control (or Megaco) Protocol. H.248 provides a standard for controlling gateway devices in multi-media packet transmissions to allow calls to connect from a LAN to a Public Switched Telephone Network (PSTN), as well as to other standards-based terminals. H.248 removes the signaling control from the media gateway, which converts data from the format required for a circuit-switched network to that required for a packet-switched network. Instead, the signaling control is in a media gateway controller, which can control multiple gateways. H.248 defines a protocol for communication between the media gateway controller and a media gateway, and can be used to set up, maintain, and terminate calls between multiple endpoints.

Even though internet telephony is moving to these new standards and protocols, companies have invested a lot of money in applications that were designed with classical switches in mind. For example, many companies have applications, toolkits, and servers that use a computer supported telecommunication applications (CSTA) protocol. CSTA enables and supports computer-telephony integration (CTI) applications, which are applications that cause telecommunications functions to be performed on behalf of users. It would be very costly for companies to convert all of their current applications, toolkits, and servers to another protocol compatible with new internet telephony standards, such as H.248.

### BRIEF DESCRIPTION OF DRAWINGS

The invention may best be understood by referring to the following description and accompanying drawings that are used to illustrate embodiments of the invention. In the drawings:

FIG. 1 illustrates is a block diagram illustrating one generalized embodiment of a system incorporating the invention.

FIG. 2 is a block diagram illustrating a suitable computing environment in which certain aspects of the illustrated invention may be practiced.

FIG. 3 is a flow diagram illustrating a method according to an embodiment of the invention.

FIG. 4 is a flow diagram illustrating another method according to an embodiment of the invention.

FIG. 5a is the first part of a protocol diagram illustrating making a call according to an embodiment of the invention.

FIG. 5b is the second part of a protocol diagram illustrating making a call according to an embodiment of the invention.

FIG. 6 is a protocol diagram illustrating clearing a call according to an embodiment of the invention.

### DETAILED DESCRIPTION

Embodiments of a system and method for providing control and monitoring functionality for a telecommunication switching domain are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

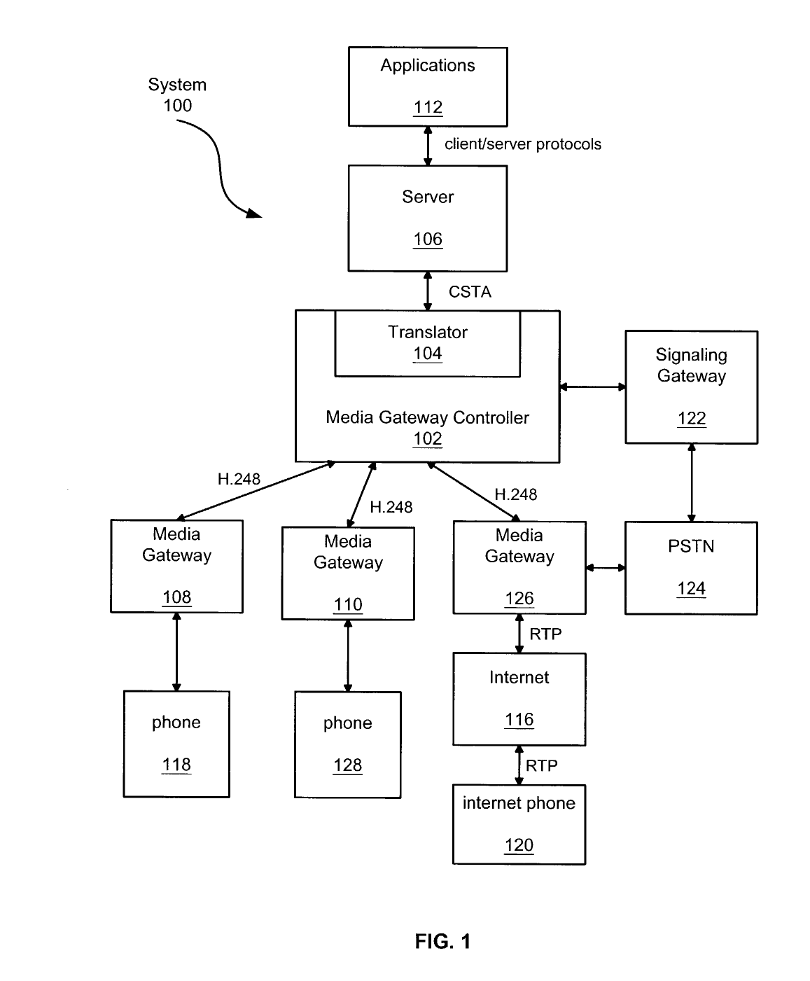

Referring to FIG. 1, a block diagram illustrates a system 100 according to one embodiment of the invention. Those of ordinary skill in the art will appreciate that the system 100 may include more components than those shown in FIG. 1. However, it is not necessary that all of these generally conventional components be shown in order to disclose an illustrative embodiment for practicing the invention.

System 100 includes a media gateway controller 102. Media gateway controller 102 includes elements and functionality necessary to implement the call system according to the standards approved by the International Telecommunications Unit (ITU) or other standards bodies including the Internet Engineering Task Force (IETF). One such standard is H.248 or Megaco. In addition, media gateway controller 102 includes a translator 104 to translate commands defined in a telecommunication applications protocol, such as a computer supported telecommunication applications (CSTA) Protocol, to a protocol capable of being understood by a media gateway. In the example shown, system 100 includes three media gateways 108, 110, and 126.

The media gateway controller 102 communicates with applications 112 through a server 106. Many applications and servers have been designed and set up with classical switches in mind. Therefore, the applications and servers use protocols that are not compatible with the standards approved by the ITU for communicating with media gateways. For example, many applications and servers use the CSTA Protocol. It would be costly to redesign these applications and servers to use H.248.

Therefore, the CSTA commands need to be translated before they can be communicated to the media gateway. The translator 104 in the media gateway controller 102 does this translation. With the translator 104, the media gateway controller 102 can translate CSTA commands received from server 106 into H.248 commands. These H.248 commands can then be processed by the media gateway controller 102 and then appropriate commands can be sent to a media gateway. Conversely, the translator 104 can translate H.248 messages into CSTA messages and send the translated messages to the server 106.

Other components of system 100 may include a signaling gateway 122 and a Public Switched Telephone Network (PSTN) 124. These other components operate in a conventional manner known in the art. A call may be made through a conventional phone 118 or 128 or through an internet phone 120. Examples of internet phones include a computer or a PDA (Personal Digital Assistant). The internet phone 120 communicates with the Internet 116 using RTP (Real Time Protocol). The Internet 116 then communicates with the media gateway 126.

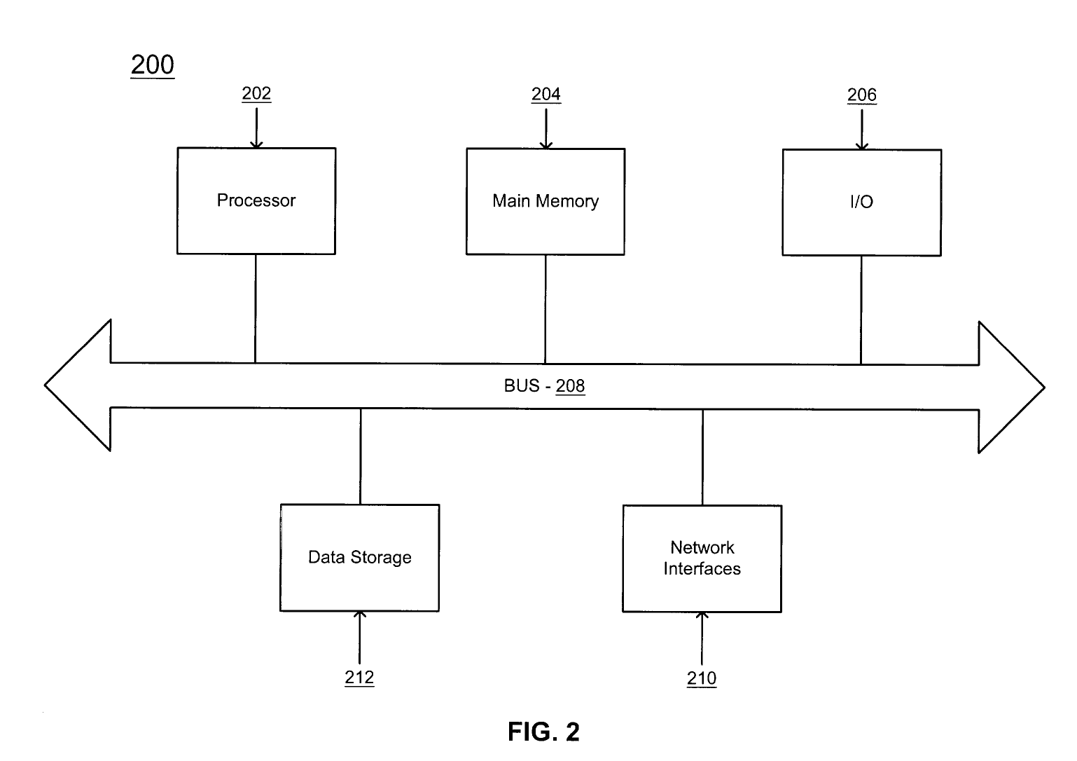

FIG. 2 is a block diagram illustrating a suitable computing environment in which certain aspects of the illustrated invention may be practiced. In one embodiment, the method for a process management system 100 may be implemented on a computer system 200 having components 202-212, including a processor 202, a memory 204, an Input/Output device 206, a data storage 212, and a network interface 210, coupled to each other via a bus 208. The components perform their conventional functions known in the art and provide the means for implementing the process management system 100. Collectively, these components represent a broad category of hardware systems, including but not limited to general purpose computer systems and specialized packet forwarding devices. It is to be appreciated that various components of computer system 200 may be rearranged, and that certain implementations of the present invention may not require nor include all of the above components. Furthermore, additional components may be included in system 200, such as additional processors (e.g., a digital signal processor), storage devices, memories, and network or communication interfaces.

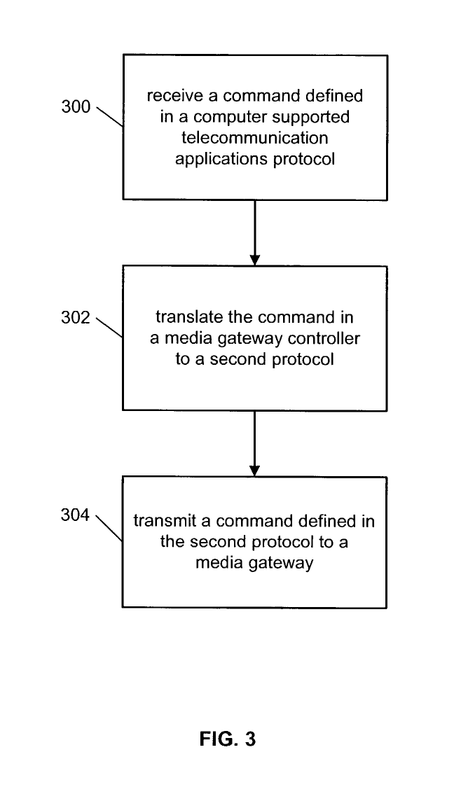

FIG. 3 is a flow diagram illustrating a method according to an embodiment of the invention. At 300, a command is received that is defined in a computer supported telecommunication applications protocol. In one embodiment, the command is received from a CSTA server 106 at a media gateway controller 102. At 302, the command is translated by the media gateway controller into a second protocol. The second protocol is a protocol that may be understood and used by a media gateway. In one embodiment, the second protocol is a H.248 or Megaco protocol. In alternative embodiments, the second protocol may be one of various media gateway control protocols, such as Simple Gateway Control Protocol (SGCP). In one embodiment, the translated command is processed by the media gateway controller. At 304, a command defined in the second protocol is transmitted to a media gateway. In one embodiment, other additional messages defined in the second protocol may be transmitted to the media gateway from the media gateway controller.

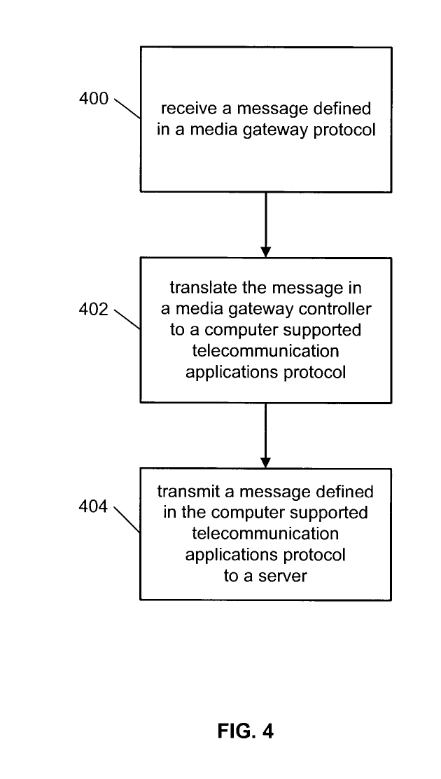

FIG. 4 is a flow diagram illustrating a method according to an embodiment of the invention. At 400, a message is received that is defined in a media gateway protocol. In one embodiment, the message is received from a media gateway. In one embodiment, the message is received at a media gateway controller 102 defined in H.248 or MegaCo. At 402, the message is translated by the media gateway controller 102 into a computer supported telecommunication applications protocol. In one embodiment, the translated message is transmitted to a server 106. In one embodiment, the translated message is processed by the media gateway controller 102. At 404, a message defined in the computer supported telecommunication applications protocol is transmitted to a server 106.

An illustrative example of a method of making a call according to one embodiment of the invention will now be described. In this example, all communications between the media gateway controller 102 and the media gateways 108 and 110 are according to the H.248 standard.

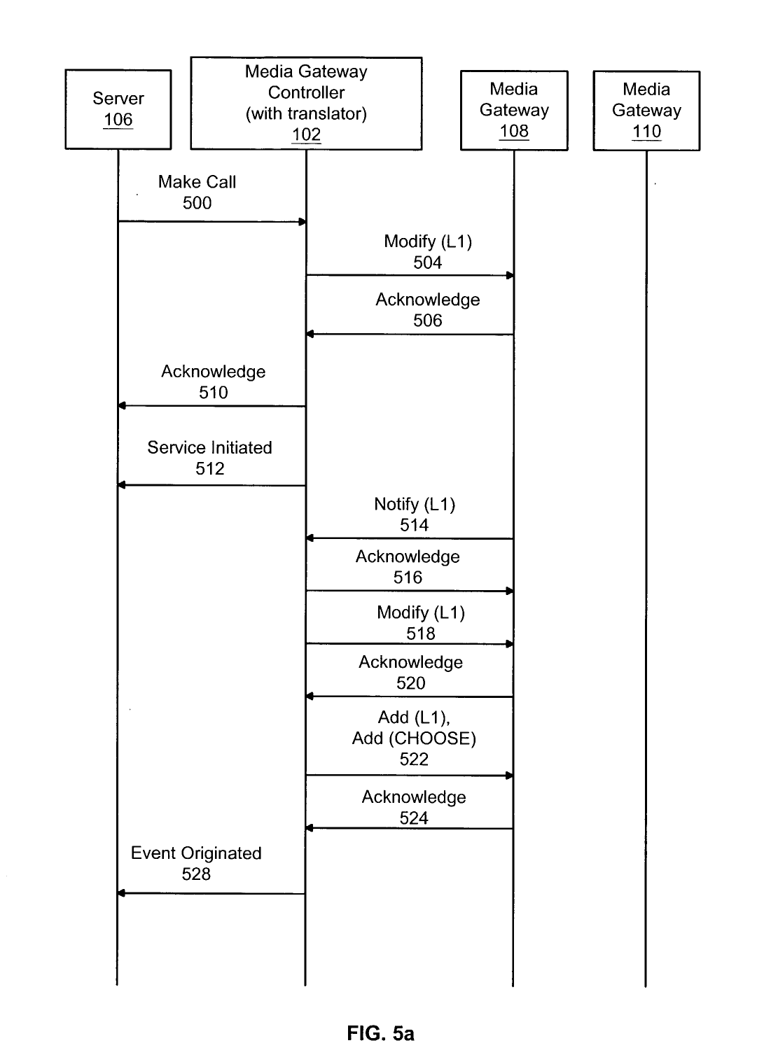

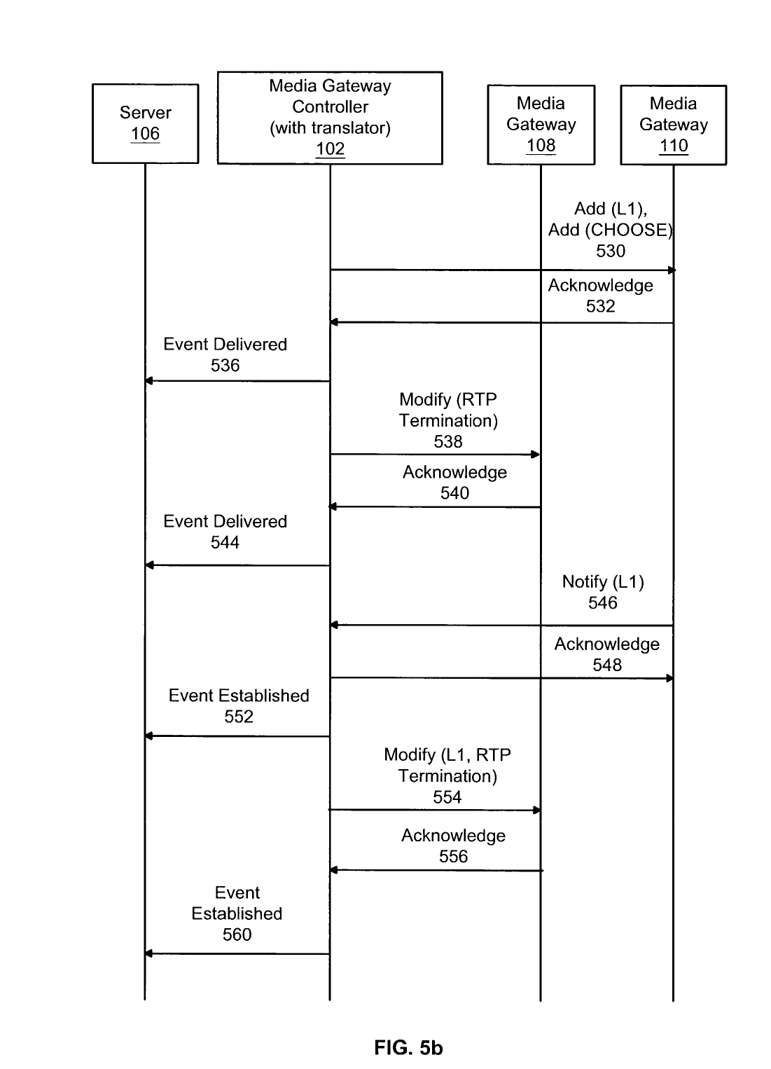

FIGS. 5a and 5b show a protocol diagram illustrating making a call according to one embodiment of the invention. For purposes of illustration, assume that a server wishes to establish a call via the CSTA Make Call service. Referring to FIG. 5a, at 500, the server 106 sends a Make Call command to the media gateway controller 102. The translator 104 in media gateway controller 102 translates the CSTA command into a H.248 command, and this H.248 command is then processed. At 504, the media gateway controller 102 sends a H.248 modify command to a media gateway 108. At 506, the media gateway 108 replies to the media gateway controller 102 with an acknowledgement. At 510, the media gateway controller 102 sends the server 106 a positive acknowledgement message. At 512, the media gateway controller 102 sends the server 106 a CSTA service initiated message.

At 514, the media gateway 108 detects an offhook event on phone 118 and notifies the media gateway controller 102. At 516, the media gateway controller 102 replies with an acknowledgement. At 518, the media gateway controller 102 then sends a modify message to the media gateway 108 to tell it to play a ringback tone. At 520, the media gateway 108 sends an acknowledgement back to the media gateway controller 102. At 522, the media gateway controller 102 sends a message to the media gateway 108 to instruct it to start an RTP stream in association with phone 118. At 524, the media gateway 108 sends an acknowledgement to the media gateway controller 102. At 528, the media gateway controller 102 sends a CSTA event originated message to the server 106.

Now referring to FIG. 5b, at 530, the media gateway controller 102 sends a message to a second media gateway 110 to instruct it to start an RTP stream in association with phone 128 and to start power ringing on the phone 128. At 532, the media gateway 110 sends an acknowledgement message to the media gateway controller 102. At 536, the media gateway controller 102 sends a CSTA event delivered message to the server 106.

At 538, the media gateway controller 102 sends a message to the media gateway 108 telling it to update the RTP termination associated with phone 118 with the IP address and RTP port associated with phone 128 on the second media gateway 110. At 540, the media gateway 108 sends an acknowledgement message to the media gateway controller 102. At 544, the media gateway controller 102 sends a CSTA event delivered message to the server 106.

At 546, the second media gateway 110 detects phone 128 is offhook and notifies the media gateway controller 102. At 548, the media gateway controller 102 sends an acknowledgement to media gateway 110. At 552, the media gateway controller 102 sends a CSTA event established message to the server 106.

At 554, media gateway controller 102 sends a message to media gateway 108 to stop the ringback tone and complete the two-way connection. At 556, media gateway 108 sends an acknowledgement message to media gateway controller 102. At 560, the media gateway controller 102 sends a CSTA event established message to the server 106. The two-way call connection has been made between phone 118 and phone 128.

An illustrative example of a method of clearing a call according to one embodiment of the invention will now be described. For purposes of illustration, assume that a connection between two media gateways 108 and 110 is being cleared based on instructions from a CSTA client application.

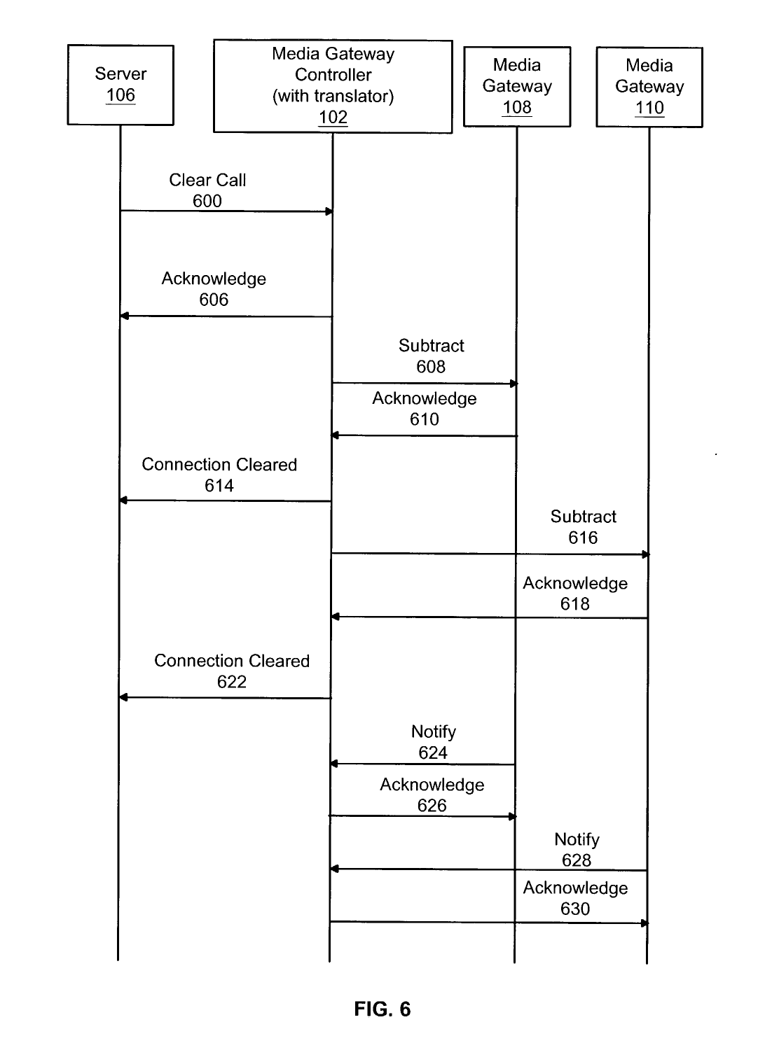

FIG. 6 shows a protocol diagram illustrating clearing a call according to one embodiment of the invention. At 600, a CSTA Clear Call command is received from the CSTA server 106 by the media gateway controller 102. The translator 104 in media gateway controller 102 translates the CSTA command into a H.248 command, and the H.248 command is then processed. At 606, the media gateway controller 102 sends a CSTA acknowledgement message to the CSTA server 106.

At 608, the media gateway controller 102 sends a H.248 message to media gateway 108 to subtract both the RTP and phone 118 terminations from the context to break the connection. The media gateway controller 102 also requests connection statistics for the RTP connection. At 610, the media gateway 108 sends an acknowledgement message to the media gateway controller 102. At 614, the media gateway controller 102 sends a CSTA connection cleared message to the CSTA server 106.

At 616, the media gateway controller 102 sends a message to media gateway 110 to subtract both the RTP and phone 128 terminations from the context to break the connection. The media gateway controller 102 also requests connection statistics for the RTP connection. At 618, the media gateway 110 sends an acknowledgement message to the media gateway controller 102. At 622, the media gateway controller 102 sends a CSTA connection cleared message to the CSTA server 106.

At 624, the media gateway 108 detects that phone 118 is onhook and notifies the media gateway controller 102. At 626, the media gateway controller 102 replies to the message by sending an acknowledgement and sets a detection for the next offhook event.

At 628, the media gateway 110 detects that phone 128 is onhook and notifies the media gateway controller 102. At 630, the media gateway controller 102 replies to the message by sending an acknowledgement and sets a detection for the next offhook event.

Other examples of CSTA services that may be implemented by a media gateway controller according to embodiments of the invention include media gateway registration, get switching function devices and monitor start, snapshot device, consultation call, transfer, set non-immediate forwarding, deactivation of forwarding when busy, clear connection (a single connection of an established call is cleared), clear call for a two party call (clearing an established call between two terminals), single step/ad hoc 3-party conference, party conference (from consultation), clear call for a three party call (clearing an established call between three terminals in a conference call), and clear connection/disconnect a single party from a three party call (clearing a single connection from a three party call).

As will be appreciated by those skilled in the art, the content for implementing an embodiment of the method of the invention, for example, computer program instructions, may be provided by any machine-readable media which can store data that is accessible by system 100, as part of or in addition to memory, including but not limited to cartridges, magnetic cassettes, flash memory cards, digital video disks, random access memories (RAMs), read-only memories (ROMs), and the like. In this regard, the system 100 is equipped to communicate with such machine-readable media in a manner well-known in the art.

It will be further appreciated by those skilled in the art that the content for implementing an embodiment of the method of the invention may be provided to the system 100 from any external device capable of storing the content and communicating the content to the system 100. For example, in one embodiment of the invention, the system 100 may be connected to a network, and the content may be stored on any device in the network.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a command defined in a first protocol, wherein the first protocol is a computer supported telecommunication applications protocol; and
translating the command in a media gateway controller to a second protocol, wherein the second protocol is understood by a media gateway.

2. The method of claim 1, wherein the second protocol is a media gateway controller protocol.

3. The method of claim 1, wherein the second protocol is a H.248 protocol.

4. The method of claim 3, further comprising processing the translated command according to the H.248 standard.

5. The method of claim 4, further comprising transmitting a message to the media gateway, wherein the message is defined in the second protocol.

6. An apparatus comprising:
a controller to control communication between a computer supported telecommunication applications server and a media gateway; and
a translator to translate messages received from the server into messages understood by the media gateway.

7. The apparatus of claim 6, wherein the controller is a media gateway controller.

8. The apparatus of claim 7, wherein the controller comprises the translator.

9. The apparatus of claim 8, wherein the received messages are messages defined by a computer supported telecommunication applications protocol.

10. The apparatus of claim 8, wherein the translated messages are defined by a H.248 protocol.

11. An article of manufacture comprising:
a machine accessible medium including content that when accessed by a machine causes the machine to:
receive a message defined in a first protocol, wherein the first protocol is a computer supported telecommunications applications protocol; and
translate the message in a media gateway controller to a second protocol, wherein the translated message is understood by a media gateway.

12. The article of manufacture of claim 11, wherein the second protocol is a media gateway controller protocol.

13. The article of manufacture of claim 11, wherein the second protocol is a H.248 protocol.

14. The article of manufacture of claim 11, further comprising a machine accessible medium including content that when accessed by a machine causes the machine to process the translated message according to the H.248 standard.

15. The article of manufacture of claim 11, further comprising a machine accessible medium including content that when accessed by a machine causes the machine to transmit another message defined in the second protocol to the media gateway.

16. A method comprising:
receiving a message defined in a media gateway protocol, wherein the media gateway protocol is understood by a media gateway; and
translating the message in a media gateway controller to a computer supported telecommunication applications protocol.

17. The method of claim 16, further comprising transmitting the translated command to a server.

18. The method of claim 16, wherein the media gateway protocol is a MegaCo protocol.

19. The method of claim 16, wherein the media gateway protocol is a Simple Gateway Control Protocol.

20. The method of claim 16, wherein the media gateway protocol is a H.248 protocol.

21. The method of claim 20, further comprising processing the translated message according to the H.248 standard.

22. The method of claim 21, further comprising transmitting another message defined in the computer supported telecommunication applications protocol to a server.

23. A system comprising:
a memory;
a processor coupled to the memory via a bus; and
logic coupled to the memory and the processor, the logic including:
a controller to control communication between a computer supported telecommunication applications server and the media gateway; and
a translator to translate a command defined by a computer supported telecommunication applications protocol, wherein the translated command may be understood by a media gateway.

24. The system of claim 23, wherein the controller is a media gateway controller.

25. The system of claim 24, wherein the controller comprises the translator.
